(19) United States
(12) Patent Application Publication
(10) Pub. No.: US 2020/0198174 A1
(43) Pub. Date: Jun. 25, 2020

(54) METHOD AND DEIVCE FOR PRODUCING A COMPOSITE WOOD BOARD

(71) Applicant: SWISS KRONO Tec AG, Luzern (CH)

(72) Inventors: Norbert KALWA, Horn-Bad Meinberg (DE); Torsten KOPP, Marnitz (DE)

(21) Appl. No.: 16/641,901

(22) PCT Filed: Sep. 12, 2018
(86) PCT No.: PCT/EP2018/074625

§ 371 Date: Feb. 25, 2020

(30) Foreign Application Priority Data
Oct. 16, 2017 (EP) 17196574.2

(51) Int. Cl. B27N 1/02; B27N 3/18; B27N 3/02; B27N 3/14; B27N 1/00; B27N 3/00; B27N 9/00

(52) U.S. Cl. CPC B27N 1/029; B27N 1/0209; B27N 3/18; B27N 9/00; B27N 3/146; B27N 1/006; B27N 3/005; B27N 3/02

(57) ABSTRACT

The disclosure relates to a method for producing a wood material panel with at least one layer with an inhomogeneous density profile, including the steps: scattering a multitude of wood particles to produce a particulate cake, pressing the particulate cake to form a layer of the wood material panel, and scattering different pre-determined quantities of wood particles in at least two areas within the particulate cake.

### FIELD OF INVENTION

The method relates to a method for producing a wood material panel, wherein the method comprises the following steps:

a) scattering a multitude of wood particles to form a particulate cake, wherein at least one adhesive is applied to at least some of the wood particles prior to and/or during scattering,

b) pressing the particulate cake under high pressure and at a high temperature to form a wood material panel.

The invention also relates to a device for conducting such a method.

### BACKGROUND

Nowadays, wood material panels are used in a wide range of applications, such as wooden floors, wall coverings, furniture or in wood construction work. Wood materials are made using wood particles and adhesive, which are pressed to form wood material panels, generally in a continuous process under the influence of heat and pressure. This method is known as “hot pressing” and can be conducted either continuously or on a cyclical basis. Well-known types of wood-based panels are, for example, OSB (Oriented Strand Board according to EN 300), in which strands can be scattered in several alternately crossing layers, chipboard according to EN 312, in which wood chips can be scattered in cover and middle layers, or fiberboard according to EN 316, in which the wood fibers are scattered to form a usually single-layer cake.

In order to save production costs in particular, it is known from the prior art to reduce the amount of scattered particles, especially at the points in the wood material panel to be produced which are not subject to particularly high mechanical loads when the panel is used. WO 2005/046950 A1 proposes controlling the quantity of scattered particles in a middle layer of the wood material panel by using control nozzles. EP 2 653 279 A1 describes the removal of particles from a scatter curtain of falling wood particles during the scattering process, thereby achieving different bulk densities in the wood material panel. The removed particles can be then added to another scatter cycle. DE 10 2013 002 259 describes the measurement of the density of the scattered particulate cake and the subsequent removal of the desired quantity of particles so as to achieve the chosen profile.

All of these methods are only possible if the composition of the particulate cake itself does not change; rather, only the quantity of the scattered particles is adjusted. In order to change other properties of wood material panels, it is known to use additives in order to influence, for example, the thermal conductivity, flammability or other properties of the wood material panel. The necessary additives are scattered into the particulate cake. If a particular property is required only in, for instance, the cover layers of a wood material panel to be produced, EP 2 487 016 A1 proposes providing a fluid which is applied to the particulate cake at a later point and then penetrates it. This is naturally only possible in the cover layers of particulate cakes.

The invention thus aims to provide a method with which physical and/or chemical properties of a wood material panel to be produced can be adjusted spatially almost without restriction. The invention solves the problem by way of a method according to the generic term in claim 1, which is characterized in that different quantities of at least one additive are introduced at different positions within the particulate cake during the scattering of the wood particles. This renders it possible to change the local composition of the particulate cake and to vary, for example, not only the quantity of particles at various points, but also to individually adjust, for instance, the ratio of wood particles to the additive and/or the ratio of the adhesive to the additive. This is not possible with a subsequent removal of particles from the particulate cake. Furthermore, inhomogeneities and the formation of layers are prevented, which would occur if the wood particles and the additives were applied in layers one after the other.

Preferably, the at least one additive contains at least one adhesive, at least one fire-retardant substance, at least one biocidal substance, at least one substance for preventing the swelling of wood, at least one foamer and/or at least one substance that alters a visual and/or haptic and/or physical and/or one chemical property of the wood material panel, such as its electrical conductivity or thermal conductivity. These may be glass beads, expanded glass or expanded clay, expandable and preferably fluid-filled plastic beads, chalk, talcum or quartz powder and/or optical brighteners such as stilbenes, which are sold under the name blancophor for example, or fluorescent organic substances. White pigments such as titanium dioxide or calcium carbonate may also be added, which produce a lighter panel. This is beneficial if, for example, a decorative element is applied to the panel by direct printing. The panel is initially primed in white, so it is practical to have as light a panel as possible. The lighter the starting material, i.e. in this case the wood material panel, the quicker the white primer takes effect.

Additionally or alternatively, other pigments or colors may be added which color the wood material panel or at least one of its cover layers. This may render possible stripes, geometric patterns or other colorings, for example, which may also be multi-colored. Coloring agents and pigments may be used alone or in combination with other, possibly colorless, additives in order to identify, for instance, a distribution and positioning of the additive. Other properties that may be changed or adjusted by the addition of at least one additive include hydrophobicity, for instance by adding paraffins, and a VOC reduction by adding appropriate scavengers. Here, the list of properties and additives described is not exhaustive; rather, it is to be considered an extract.

The bulk density of the panel to be produced is reduced at certain points by way of expansion agents, such as glass beads, expanded glass or expanded clay, which is particularly beneficial if mechanical loads are not anticipated at the desired points, or at least not to any considerable degree. The panel can therefore be designed to be lighter and thus easier to handle for the end consumer.

Different positions within the particulate cake, at which different quantities of an additive are inserted during the scattering process, may differ in all three spatial dimensions. Different distributions in the x and/or y direction may be used within one layer and of course, the use of different distributions in a perpendicular z direction is also possible. Many properties are only used, for example, in the peripheral areas of a wood material panel or in the central area of the wood material panel. As a result, an impregnation against penetrating moisture, especially in the cover layers, is beneficial, while a lower bulk density and therefore a lower weight, particularly in the central core layer, is practical. Of course, it may also be practical to provide certain properties in some strips or areas of the wood material panel, but distributed across the entire thickness of the panel. For example, this may refer to thermal conductivity when wood material panels are being used as wooden elements in construction. Electrical conductivity or resistance against fungal infestations, for instance, which may be caused by biocidal substances, can occur to different degrees in spatially different areas.

Preferably, different additives and/or different quantities of different additives are introduced at different positions within the particulate cake. For many applications, it is beneficial to use several different additives in one wood material panel, especially in order to influence different properties. Here, each of the different additives may exhibit a spatially inhomogeneous distribution, thereby potentially causing the situations mentioned to occur. While only one or some of the additives used are present at certain points, several different points contain all additives; however, the ratios of the various additives differ in these positions. In this case, there are barely any restrictions on the ratios themselves.

Preferably, the quantity of wood particles which are scattered to form a particulate cake also varies depending on their anticipated position in the particulate cake. In this case, the quantity of scattered wood particles and the type and/or quantity of additives introduced is preferably selected in such a way that the wood material panel has a homogeneous bulk density.

### SUMMARY

The invention also solves the problem by way of a device for conducting a given method, which features an introduction device and an electric control system, which is configured to control the introduction device such that different quantities of at least one additive are introduced at different positions within the particulate cake during the scattering of the wood particles.

The electric control system preferably features an electronic data processing device that is configured to access information saved in an electronic memory and, based on this information, to control the introduction device. The electric memory may form part of the device. Alternatively or additionally, the electric control system has an interface for communicating with an external electronic data processing installation, such as a laptop or a computer, wherein the electronic memory forms part of this electronic data processing installation. The communication may occur in a wired or wireless manner, for example via WiFi or Bluetooth.

The introduction device preferably comprises at least one scattering head with at least one scattering nozzle for scattering wood particles and at least one additive nozzle for scattering at least one additive. It is especially preferable if the at least one scattering head has at least two different additive nozzles for scattering different additives.

### BRIEF DESCRIPTION OF DRAWINGS

In the following, an example of an embodiment of the present invention will be explained in more detail by way of the attached figures: They show:

FIG. 1 shows the schematic depiction of a device for conducting a method, and

FIG. 2 shows the schematic depiction of a wood material panel.

### DETAILED DESCRIPTION

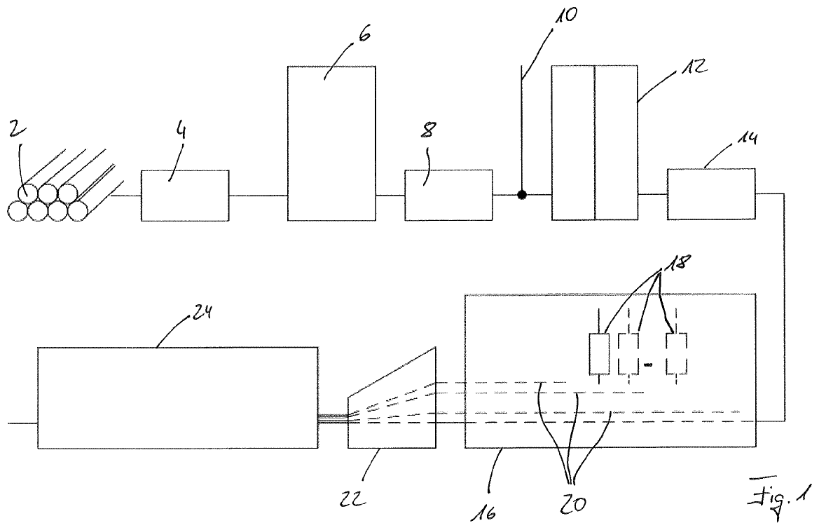

FIG. 1 depicts a device for producing a wood material panel. First of all, wood 2 is provided, which is comminuted in a comminutor 4 to produce woodchips. These are then washed in a washing device 6 and subsequently boiled in a pressure tank; this is followed by fiber maceration in a refiner 8. After the refiner, glue is added in a gluing device 10, thereby producing glued wood particles. These are dried in a drying device 12 and subsequently subjected to a quality check in a separator. The glued wood particles are then fed into an introduction device 16, which in the example of an embodiment shown features several scattering heads 18, of which three are depicted. Here, only the left-hand scattering head 18 is depicted by solid lines. The remaining heads are depicted with dashed lines so as to indicate that they are optional. The various scattering heads 18 are used to scatter different additives, thereby introducing them into the scattered particulate cake. An additional scattering head, not depicted here, is available for scattering the wood particles. The dashed lines 20 of different lengths serve to show that different additives are scattered from different scatter heads 18. Alternatively to the embodiment depicted, it is also possible to use different scattering heads 18 to first mix the scatter particles with the additives and then to apply them via an aggregate scattering head, not depicted in FIG. 1. This ensures that the required additives and materials are present in a mixed form at the respective positions in the wood material panel to be produced. This prevents layers from forming.

The particulate cake which is scattered in this manner then reaches a pre-compactor 22 before being pressed in a hot press 24 to form a wood material panel.

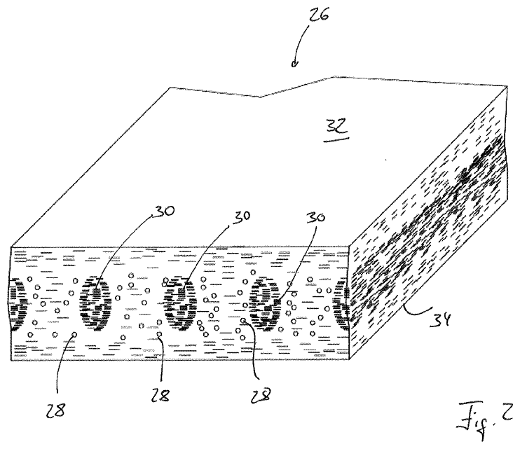

FIG. 2 shows a schematic sectional view through a wood material panel 26. A first additive 28 can be clearly seen, which is depicted in the form of small circles and which may be, for instance, glass beads or expanded clay; said additive is distributed almost homogeneously in one plane between an upper side 32 and a lower side 34. This allows, for instance, the bulk density of the wood material panel 26 to be reduced in this area, thereby saving on weight. A second additive 30, which is depicted in the form of dashes, is arranged in the shape of rods in the wood material panel 26. This may be an additive which increases or reduces the electrical conductivity and/or thermal conductivity of the panel, for example, which creates certain transport routes for heat and/or an electrical charge.

1. A method for producing a wood material panel, comprising:
(a) scattering a multitude of wood particles to produce a particulate cake, wherein at least one adhesive is applied to at least some of the wood particles prior to and/or during scattering,
(b) pressing the particulate cake under high pressure and at a high temperature to form a wood material panel, and
(c) introducing different quantities of at least one additive at different positions within the particulate cake during the scattering of the wood particles.

2. The method according to claim 1, wherein the at least one additive contains at least one adhesive, at least one fire-retardant substance, at least one biocidal substance, at least one substance for preventing the swelling of wood, at least one foamer and/or at least one substance that alters a visual and/or haptic and/or physical property of the wood material panel.

3. The method according to claim 1, wherein the different additives and/or different quantities of various additives are introduced at different positions within the particulate cake.

4. The method according to claim 1, wherein a quantity of wood particles, which are scattered to form the particulate cake, is varied depending on their anticipated position in the particulate cake.

5. The method according to claim 4, wherein the quantity of the scattered wood particles and the type and/or quantity of the additives introduced is selected in such a way that the wood material panel has a homogeneous bulk density.

6. A device for conducting a method according to claim 1 which comprises an introduction device and an electric control system, which is configured to control the introduction device such that different quantities of the at least one additive are introduced at different positions within the particulate cake during the scattering of the wood particles.

7. The device according to claim 6, wherein the electrical control system has an electronic data processing device that is configured to access information saved in an electronic memory and, based on this information, to control the introduction device.

8. The device according to claim 6, wherein the introduction device comprises at least one scattering head with at least one scattering nozzle for scattering the wood particles and at least one scattering head for scattering the at least one additive.

9. The device according to claim 8, wherein the at least one scattering head comprises at least two different additive nozzles for scattering different additives.

10. The method according to claim 2, wherein the physical property of the wood material panel is its electrical conductivity or thermal conductivity.
